(19) United States
(12) Patent Application Publication
(10) Pub. No.: US 2008/0020726 A1
(43) Pub. Date: Jan. 24, 2008

(54) N-port signal separation apparatus with improved frequency selectivity and dynamic range

(76) Inventors: David V. Blackham, Santa Rosa, CA (US); Kenneth H. Wong, Santa Rosa, CA (US); Keith F. Anderson, Santa Rosa, CA (US); Hassan Tanbakuchi, Santa Rosa, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/486,924

(22) Filed: Jul. 14, 2006

(51) Int. Cl. H04B 1/06; H04B 7/00

(52) U.S. Cl. 455/249.1

(57) ABSTRACT

A vector network analyzer with one or more ports having each port comprising of an N-port signal separating network, where N>=6, an intermediate frequency (IF) filter interposing an RF downconverter and a power detector. The RF downconverter may be N-2 mixers or N-2 samplers. The IF downconverter (comprising N-2 IF filters and power detectors) may also be realized by an AID converter having N-2 inputs connected to a digital signal processor.

### BACKGROUND

Majority of commercially available vector network analyzers (VNAs) use detectors in conjunction with signal separation devices to measure the reflection magnitude and phase of device at high frequencies. The vector detectors are either mixer based or sampler based with intermediate frequency (IF) filtering (either digital or analog) which increases the dynamic range and minimizes the sensitivity to spectral impurities. To maintain phase coherence, a common local oscillator (LO) signal is used by all test ports.

A six-port network analyzer (shown in FIG. 1) uses four scalar detectors offset from each other. The combination of the offset scalar signals allows the reconstruction of the signal's relative phase. The scalar detectors have a broadband nature that leads to a lower dynamic range and sensitivity to spectral impurities of the source. Due to the detector phase offset requirements, a single six-port network can provide 2:1 bandwidth coverage while comparable vector detector VNAs provide greater than 100:1 bandwidth.

### SUMMARY

A vector network analyzer with one or more ports having each port comprising of an N-port signal separating network, where N>=6, an intermediate frequency (IF) filter interposing an RF downconverter and a power detector. The RF downconverter may be N-2 mixers or N-2 samplers. The IF downconverter (comprising N-2 IF filters and power detectors) may also be realized by an A/D converter having N-2 inputs connected to a digital signal processor.

### BRIEF DESCRIPTION OF THE DRAWINGS

FIG. 1 illustrates a six port detector of the prior art.

FIG. 2 illustrates an embodiment of the invention.

FIG. 3 illustrates an embodiment of the invention.

FIG. 4 illustrates an embodiment of the invention.

FIG. 5 illustrates an embodiment of the invention.

FIG. 6 illustrates an embodiment of the invention.

FIG. 7 illustrates an embodiment of the invention.

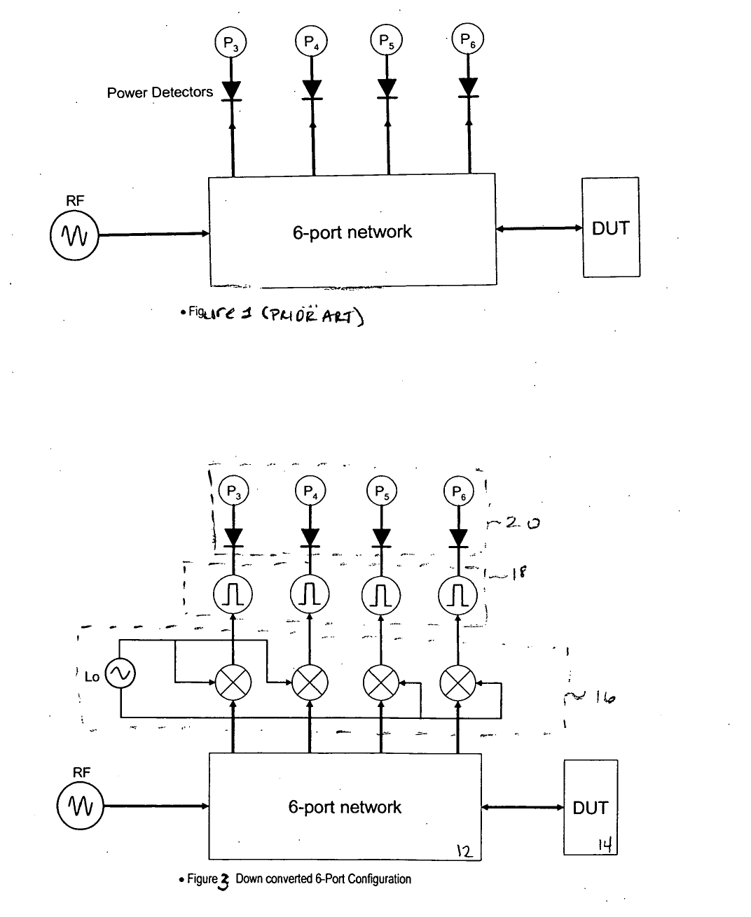

### DETAILED DESCRIPTION

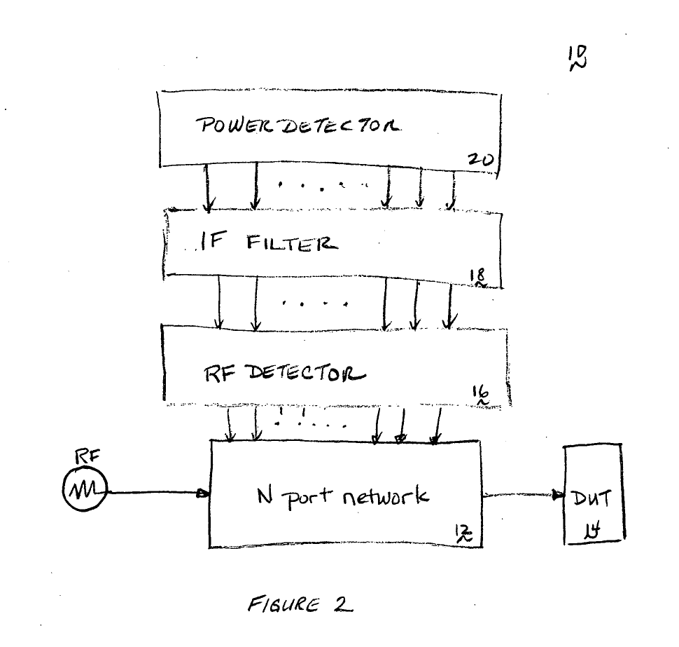

FIG. 2 illustrates an embodiment the signal separation network of the present invention 10 for use in a vector network analyzer (not shown). An N port network analyzer 12 receives an RF signal. The analyzer 12 is bidirectionally connected with a device under test (DUT) 14. Each of the N-2 ports is received by an RF downconverter 16 having N-2 outputs. Each of the N-2 outputs is received by an N-2 input IF filter 18. A power detector 20 receives the outputs of the IF filter 18.

FIG. 3 illustrates an embodiment of the present invention. The RF downconverter 16 is implemented by N-2 mixers, each receiving a local oscillator (LO) signal. The IF filter is implemented by N-2 bandpass filters.

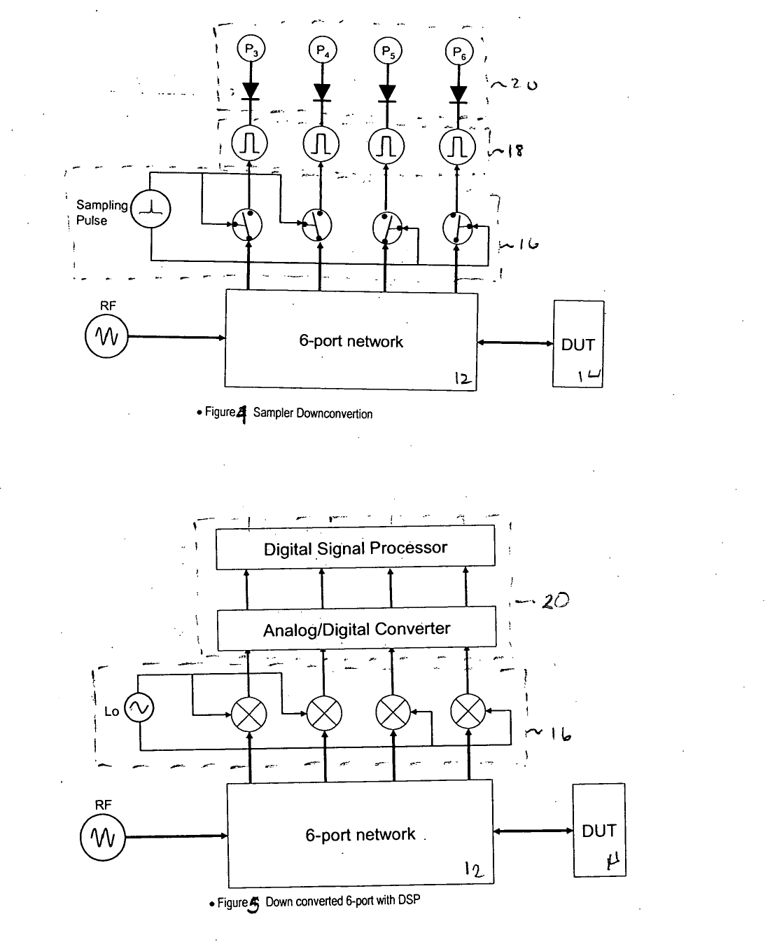

FIG. 4 illustrates an embodiment of the present invention. The RF downconverter 16 is implemented by N-2 samplers, each receiving a sampling pulse. The IF filter 18 is implemented by N-2 bandpass filters.

FIG. 5 illustrates an embodiment of the present invention. The RF downconverter 16 is implemented by N-2 mixers, each receiving a local oscillator (LO) signal. The power detector 20 is implemented by an analog to digital A/D converter connected to a digital signal processor. The IF filter 18 is implemented in the digital single processor.

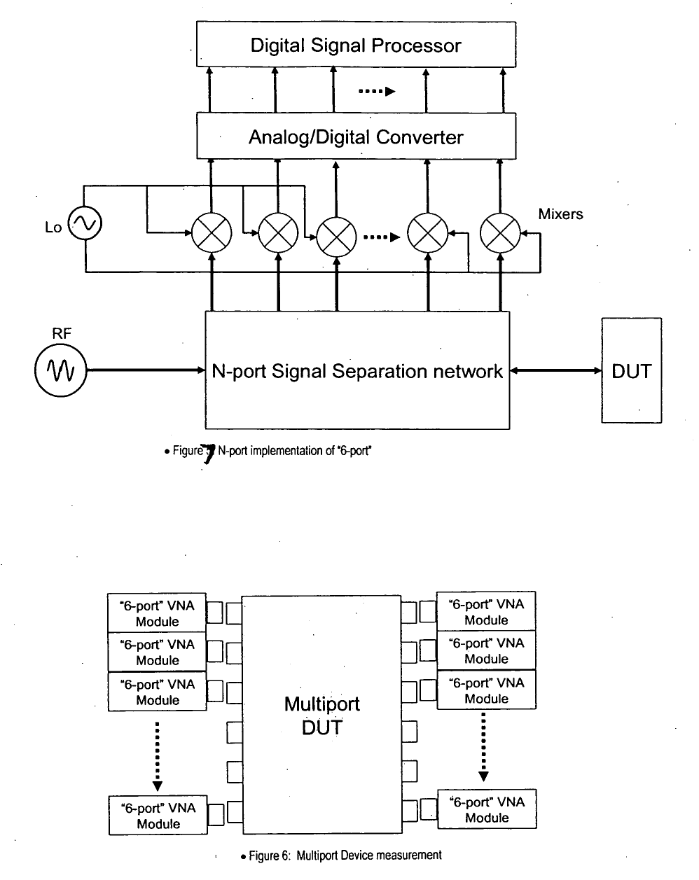

Since the signal detection is scalar, the phase coherency requirement of the local oscillator is eliminated. This simplifies the LO signal distribution. The LO requirements can be met by a synthesized LO signal. A series of VNA modules can be coordinated to create a multi-port VNA measurement system as illustrated in FIG. 6. Since the modules can be made small, it is possible to eliminate test port cables by connecting the modules directly to the DUT.

Each measurement port of the signal separation network is downconverted to an IF where filtering can improve both the dynamic range and isolation from spectral impurities. The down conversion may be accomplished using mixers (shown in FIG. 2) or samplers (shown in FIG. 3). The filtering and signal detection may be implemented using A/D converters and digital signal processors (shown in FIG. 4).

As shown in FIG. 7, the usable frequency range of a 6-port network analyzer may be extended by adding more detector ports to provide the necessary phase offsets.

Although the present invention has been described in detail with reference to particular embodiments, persons possessing ordinary skill in the art to which this invention pertains will appreciate that various modifications and enhancements may be made without departing from the spirit and scope of the claims that follow.

We claim:

1. An apparatus comprising:
an N-port signal separation network, where N≧6;
one of the N-ports is connected to a RF signal source,
another one of the N-ports is used as the test port,
a radio frequency (RF) downconverter having N-2 inputs and N-2 outputs, each input corresponding to and connecting to one of the remaining N-2 ports;
an intermediate frequency (IF) filter stage having N-2 inputs and N-2 outputs, each input corresponding to and connecting to one of the N-2 outputs of RF downconverter; and
a power detector stage having N-2 inputs, each input corresponding to and connecting to one of the N-2 outputs of the IF filter.

2. An apparatus, as in claim 1, the RF downconverter further comprising N-2 mixers.

3. An apparatus, as in claim 1, the RF downconverter further comprising N-2 samplers.

4. An apparatus, as in claim 1, the IF filter stage including N-2 bandpass filters.

5. An apparatus, as in claim 4, the RF downconverter further comprising N-2 mixers.

6. An apparatus, as in claim 4, the RF downconverter further comprising N-2 samplers.

7. An apparatus, as in claim 1, the IF filter stage and the power detector stage including:
an analog to digital converter receiving the N inputs from the RF downconverter stage, having N-2 outputs; and
a digital signal processor receiving the N-2 outputs of the analog to digital converter.

8. An apparatus, as in claim 7, the RF downconverter further comprising N-2 mixers.

9. An apparatus, as in claim 7, the RF downconverter further comprising N-2 samplers.

10. A vector network analyzer including an apparatus as defined in claim 1.

11. A vector network analyzer as in claim 10, the RF downconverter further comprising N-2 mixers.

12. A vector network analyzer as in claim 10, the RF downconverter further comprising N-2 samplers.

13. A vector network analyzer as in claim 10, the IF filter stage including N-2 bandpass filters.

14. A vector network analyzer as in claim 13, the RF downconverter further comprising N-2 mixers.

15. A vector network analyzer as in claim 13, the RF downconverter further comprising N-2 samplers.

16. A vector network analyzer as in claim 10, the IF filter stage and the power detector stage including:
an analog to digital converter receiving the N inputs from the RF downconverter stage, having N-2 outputs; and
a digital signal processor receiving the N-2 outputs of the analog to digital converter.

17. A vector network analyzer as in claim 16, the RF downconverter further comprising N-2 mixers.

18. A vector network analyzer as in claim 16, the RF downconverter further comprising N-2 samplers.
